(19) United States
(12) Patent Application Publication
(10) Pub. No.: US 2015/0269430 A1
(43) Pub. Date: Sep. 24, 2015

(54) RECOGNITION APPARATUS, METHOD, AND COMPUTER PROGRAM PRODUCT

(71) Applicant: Kabushiki Kaisha Toshiba, Tokyo (JP)

(72) Inventor: Yojiro TONOUCHI, Inagi Tokyo (JP)

(21) Appl. No.: 14/645,146

(22) Filed: Mar. 11, 2015

(30) Foreign Application Priority Data
Mar. 20, 2014 (JP) 2014-058704

(51) Int. Cl. G06K 9/00; G06K 9/34; G06K 9/22

(52) U.S. Cl. CPC G06K 9/00416; G06K 9/00865; G06K 9/222; G06K 9/34

(57) ABSTRACT

A recognition apparatus includes an acquisition unit to acquire strokes, a detector to detect endpoints of each stroke, a setting unit to set a determination region for each endpoint, first to third determination units, and a recognizer. The first determination unit determines whether first one or more strokes are included in a first determination region. The second determination unit determines, when the first one or more strokes are included, whether the first one or more strokes constitute a first figure. The third determination unit determines, when the first one or more strokes constitute the first figure, whether second one or more strokes comprising the detected endpoints in the first determination region constitute a second figure. The recognizer recognizes, when the second one or more strokes constitute the second figure, the first one or more strokes and the second one or more strokes as a third figure.

### CROSS-REFERENCE TO RELATED APPLICATION(S)

This application is based upon and claims the benefit of priority from Japanese Patent Application No. 2014-058704, filed on Mar. 20, 2014; the entire contents of which are incorporated herein by reference.

### FIELD

Embodiments described herein relate generally to a recognition apparatus, a method, and a computer program product.

### BACKGROUND

Techniques for recognizing a plurality of strokes handwritten by a user as graphics data are known.

However, since the above-described conventional techniques recognize strokes in accordance with a shape of an entire figure, if there is a possibility that a portion of a figure to be recognized takes various shapes, it is difficult to recognize the figure.

### BRIEF DESCRIPTION OF THE DRAWINGS

FIG. 1 is a configuration diagram illustrating an example of a recognition apparatus according to a first embodiment;

FIG. 2 is a diagram illustrating an example of a plurality of strokes according to the first embodiment;

FIG. 3 is a diagram illustrating an example of detection of endpoints of each of the plurality of strokes according to the first embodiment;

FIG. 4 is a diagram illustrating an example of a determination region according to the first embodiment;

FIG. 5 is a diagram illustrating an example of the determination region according to the first embodiment;

FIG. 6 is a diagram illustrating an example of the determination region according to the first embodiment;

FIG. 7 is a diagram illustrating an example of the determination region according to the first embodiment;

FIG. 8 is a diagram illustrating an example of determination of whether each of the strokes is included in a determination region according to the first embodiment;

FIG. 9 is a flow chart illustrating an example of recognition process according to the first embodiment;

FIG. 10 is a configuration diagram illustrating an example of a recognition apparatus according to a second embodiment;

FIG. 11 is a diagram illustrating an example of a decision technique of the strokes to be determined according to the second embodiment; and

FIG. 12 is a diagram illustrating an example of a hardware configuration of the recognition apparatus according to each embodiment and each modification.

### DETAILED DESCRIPTION

According to an embodiment, a recognition apparatus includes an acquisition unit, a detector, a setting unit, a first determination unit, a second determination unit, a third determination unit, a recognizer, and an output unit. The acquisition unit acquires a plurality of strokes. The detector detects endpoints of each of the plurality of strokes. The setting unit sets a determination region for each of the endpoints. The first determination unit determines whether first one or more strokes are included in a first determination region. The second determination unit determines, when the first one or more strokes are included in the first determination region, whether the first one or more strokes constitute a first figure. The third determination unit determines, when the first one or more strokes constitute the first figure, whether second one or more strokes comprising the detected endpoints in the first determination region constitute a second figure. The recognizer recognizes, when the second one or more strokes constitute the second figure, the first one or more strokes and the second one or more strokes as a third figure. The output unit outputs the recognized third figure.

Various embodiments will be described in detail below with reference to the accompanying drawings.

When there is a possibility that a portion of a figure to be recognized takes various shapes, recognition of all the possible shapes of the figure to be recognized requires that dictionary data be prepared for each possible shape of the figure to be recognized, leading to unrealistic increase in a storage area and increase in processing loads. Accordingly, in the embodiments below, an explanation will be made on a technique to achieve highly precise recognition without increase in a storage area or increase in processing loads even if it is possible that a portion of the figure to be recognized takes various shapes.

In the embodiments below, an example will be explained in which the figure to be recognized is an arrow. An arrow figure includes a head part and a shaft part, and the shaft part can take various shapes, such as a straight line, a broken line, and a curved line. Accordingly, the arrow figure can take various shapes as a whole. However, the figure to be recognized is not limited to an arrow and may be any figure having a portion that can take various shapes. In more detail, the figure to be recognized may be any figure in which the portion that can take various shapes is a linear figure, and a portion that can take a fixed shape like a symbol is located at an endpoint portion of the linear figure.

### First Embodiment

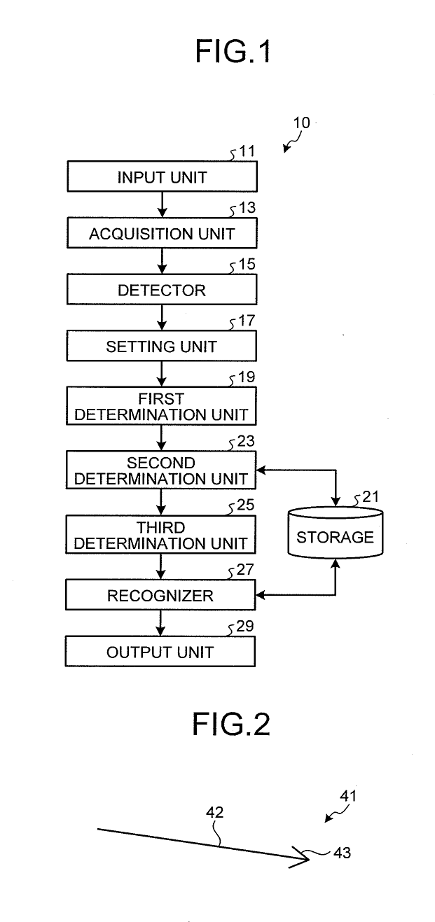

FIG. 1 is a configuration diagram illustrating an example of a recognition apparatus 10 according to a first embodiment. As illustrated in FIG. 1, the recognition apparatus 10 includes an input unit 11, an acquisition unit 13, a detector 15, a setting unit 17, a first determination unit 19, a storage 21, a second determination unit 23, a third determination unit 25, a recognizer 27, and an output unit 29.

The input unit 11 can be implemented with an input device capable of handwriting input, such as a touch panel, a touchpad, a mouse, and an electronic pen. The acquisition unit 13, the detector 15, the setting unit 17, the first determination unit 19, the second determination unit 23, the third determination unit 25, the recognizer 27, and the output unit 29 may be implemented by, for example, causing a processing device, such as a central processing unit (CPU), to execute a program, that is by software, may be implemented by, for example, hardware, such as an integrated circuit (IC), and may be implemented by software and hardware together. The storage 21 can be implemented by, for example, a storage device that can store data magnetically, optically, or electrically, such as a hard disk drive (HDD), a solid state drive (SSD), a memory card, an optical disc, a read only memory (ROM) and a random access memory (RAM).

The input unit 11 inputs a plurality of strokes created by a user handwriting a figure or the like into the recognition apparatus 10. In the first embodiment, it is assumed that the input unit 11 is a touch panel, and that the user inputs the plurality of strokes by handwriting the figure or the like on the touch panel by using a stylus pen or a finger, but the first embodiment is not limited to this case. For example, the input unit 11 may be implemented by a touchpad, a mouse, an electronic pen, and the like.

A stroke is vector data representing one stroke of the figure or the like handwritten by the user, that is, a trajectory of the stylus pen or the finger from a touch on an input surface of the touch panel until away from the input surface (from pen down until pen up), and can be represented as, for example, time-series coordinate values of a contact point between the stylus pen or the finger and the input surface.

The stroke can be represented as, for example, {(x (j, 1), y (j, 1)), (x (j, 2), y (j, 2)), . . . , (x (j, N (j)), y (j, N (j)))}. j represents a stroke count of the stroke, and N (j) represents the number of sampling points at a time of sampling a j-th stroke.

FIG. 2 is a diagram illustrating an example of a plurality of strokes 41 according to the first embodiment. In the example illustrated in FIG. 2, the plurality of strokes 41 include a stroke 42 that is a first stroke and a stroke 43 that is a second stroke. The plurality of strokes 41 represent strokes of an arrow, the stroke 42 is a stroke of a shaft part, and the stroke 43 is a stroke of a head part.

In the example illustrated in FIG. 2, the stroke 42 can be represented as {(x (1, 1), y (1, 1)), (x (1, 2), y (1, 2)), . . . , (x (1, N (1)), y (1, N (1)))}. The stroke 43 can be represented as {(x (2, 1), y (2, 1)), (x (2, 2), y (2, 2)), . . . , (x (2, N (2)), y (2, N (2)))}.

The acquisition unit 13 acquires the plurality of strokes input from the input unit 11.

The detector 15 detects endpoints of the plurality of strokes acquired by the acquisition unit 13. In the first embodiment, the detector 15 detects a starting point and an end point of each of the plurality of strokes.

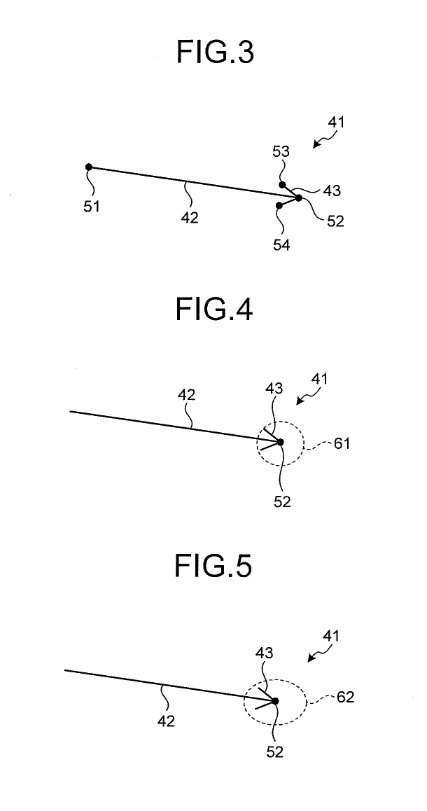

FIG. 3 is a diagram illustrating an example of detection of endpoints of each of the plurality of strokes 41 according to the first embodiment. In the example illustrated in FIG. 3, the detector 15 detects a starting point (x (1, 1), y (1, 1)) of the stroke 42 as an endpoint 51, an end point (x (1, N (1)), y (1, N (1))) of the stroke 42 as an endpoint 52, a starting point (x (2, 1), y (2, 1)) of the stroke 43 as an endpoint 53, and an end point (x (2, N (2)), y (2, N (2))) of the stroke 43 as an endpoint 54.

However, the detector 15 does not need to detect endpoints of all the strokes that constitute the plurality of strokes. The detector 15 may detect, for example, endpoints of one or more strokes that satisfy predetermined conditions from among the plurality of strokes. Examples of the predetermined conditions include a stroke having a stroke length equal to or longer than a first threshold. The stroke length can be calculated by, for example, Equation (1).

L(j)=Σᵢ₌₁^{N(j)-1}{square root over ((x(j,i)−x(j,i+1))²+(y(j,i)−y(j,i+1))²)} (1)

A variable i represents the number of sampling points at a time of sampling a j-th stroke.

The setting unit 17 sets a determination region for each endpoint detected by the detector 15. Specifically, for each endpoint detected by the detector 15, the setting unit 17 sets the determination region that includes the endpoint.

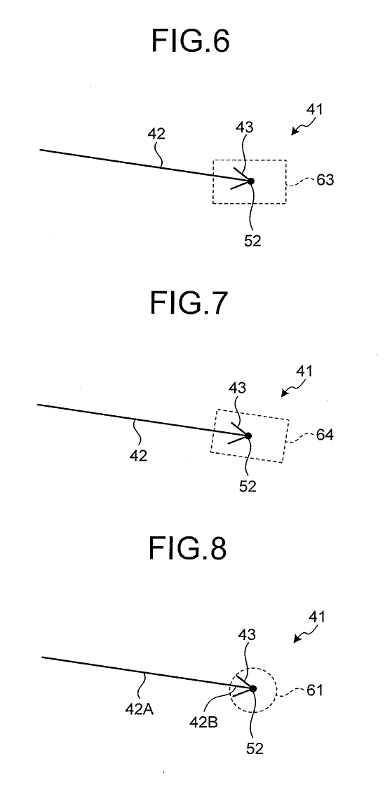

FIG. 4 to FIG. 7 are diagrams each illustrating an example of the determination region according to the first embodiment. While each of the examples illustrated in FIG. 4 to FIG. 7 illustrates a case where the determination region is set at the endpoint 52, a determination region can be set for another endpoint by a similar technique. The setting unit 17 may set a circular determination region 61 centered on the endpoint 52 as illustrated in FIG. 4, may set an elliptical determination region 62 centered on the endpoint 52 as illustrated in FIG. 5, and may set a rectangular determination region 63 centered on the endpoint 52 as illustrated in FIG. 6.

A size of the determination region may be fixed, and may be proportional to a stroke length of a stroke having an endpoint for which the determination region is set. The setting unit 17 may also set a rotated rectangular determination region 64 centered on the endpoint 52 as illustrated in FIG. 7. In the example illustrated in FIG. 7, the setting unit 17 sets the rotated determination region 64 so that a direction of the stroke 42 having the endpoint 52 coincides with a longitudinal direction of the determination region 64.

The first determination unit 19 determines, for each determination region that is set by the setting unit 17, whether one or more strokes are included in the determination region. When a stroke is entirely included in the determination region, the first determination unit 19 determines that the stroke is included in the determination region. For example, in the example illustrated in FIG. 6, since the stroke 43 is entirely included in the determination region 63, the first determination unit 19 determines that the stroke 43 is included in the determination region 63.

Specifically, the first determination unit 19 defines the determination region as R(x_min, y_min, x_max, y_max). When a coordinate P(x, y) of the stroke satisfies x_min≦x≦x_max and y_min≦y≦y_max, the first determination unit 19 determines that the coordinate P(x, y) is within R. This condition is defined as inRect(P; R). When inRect(x(j, i), y(j, i); R) is satisfied at all i, the first determination unit 19 determines that the j-th stroke is included in the determination region.

When a portion of a stroke is included in a determination region, the first determination unit 19 may divide the stroke into a partial stroke that is included in the determination region and a partial stroke that is not included in the determination region, and the partial stroke included in the determination region may be determined to be included in the determination region. For example, as in the example illustrated in FIG. 8, the first determination unit 19 may divide the stroke 42 into a partial stroke 42B that is included in the determination region 61 and a partial stroke 42A that is not included in the determination region 61, and may determine that the partial stroke 42B included in the determination region is included in the determination region 61.

In this case, the first determination unit 19 may determine whether each partial stroke is included in the determination region 61 in units of line segment instead of units of stroke. For example, when inRect(x(j, i), y(j, i); R) & inRect(x(j, i+1), y(j, i+1); R) is satisfied, the first determination unit 19 determines that a line segment (x(j, i), y(j, i)) (x(j, i+1), y(j, i+1) is included in the determination region. Then, line segments determined to be included in the determination region are combined to generate a partial strike. The first determination unit 19 divides the stroke into a partial stroke that is included in the determination region and a partial stroke that is not included in the determination region, and can determine that the partial stroke included in the determination region is included in the determination region.

The storage 21 stores therein data such as dictionary data for determining whether the stroke constitutes a first figure or a second figure. In the present embodiment, the first figure is a shape of the head part of the arrow and the second figure is a shape of the shaft part of the arrow, but the first figure and the second figure are not limited to these shapes.

When the first determination unit 19 determines that one or more strokes are included in the determination region, the second determination unit 23 determines whether the one or more strokes constitute the first figure. For example, the second determination unit 23 calculates a feature value of one or more strokes determined to be included in the determination region, calculates a distance between the calculated feature value and a value of a representative model of the first figure defined by the dictionary data stored in the storage 21. When the calculated distance is equal to or smaller than a second threshold, the second determination unit 23 determines that the one or more strokes constitute the first figure. As the feature value of one or more strokes, the second determination unit 23 may calculate, for example, the feature value described in Japanese Patent No. 5214367 by imaging the one or more strokes.

When the second determination unit 23 determines that one or more strokes constitute the first figure, the third determination unit 25 determines whether the stroke having the endpoint, at which the determination region including the one or more strokes is set, constitutes the second figure.

For example, based on a positional relationship between one or more strokes and the stroke having the endpoint at which the determination region including the one or more strokes is set, the third determination unit 25 determines whether the stroke having the endpoint, at which the determination region including the one or more strokes is set, constitutes the second figure. For example, when a distance between the other endpoint of the stroke having the endpoint, at which the determination region including the one or more strokes is set, and the one or more strokes is equal to or greater than a third threshold, the third determination unit 25 determines that the stroke having the endpoint, at which the determination region including the one or more strokes is set, constitutes the second figure.

The third determination unit 25 may determine whether the stroke having the endpoint, at which the determination region including the one or more strokes is set, constitutes the second figure by further using a shape of the stroke having the endpoint at which the determination region including the one or more strokes is set.

When the third determination unit 25 determines that the stroke having the endpoint, at which the determination region including the one or more strokes is set, constitutes the second figure, the recognizer 27 recognizes, as a third figure, the one or more strokes and the stroke having the endpoint at which the determination region including the one or more strokes is set. In the present embodiment, the third figure is a shape of the entire arrow, but the third figure is not limited to this shape.

For example, the recognizer 27 recognizes, as the third figure, one or more strokes and the stroke having the endpoint, at which the determination region including the one or more strokes is set, by using the representative model of the first figure and the second figure defined by the dictionary data stored in the storage 21.

The output unit 29 outputs the third figure recognized by the recognizer 27. For example, the output unit 29 outputs the third figure recognized by the recognizer 27 to a display device or the like (not illustrated) for display.

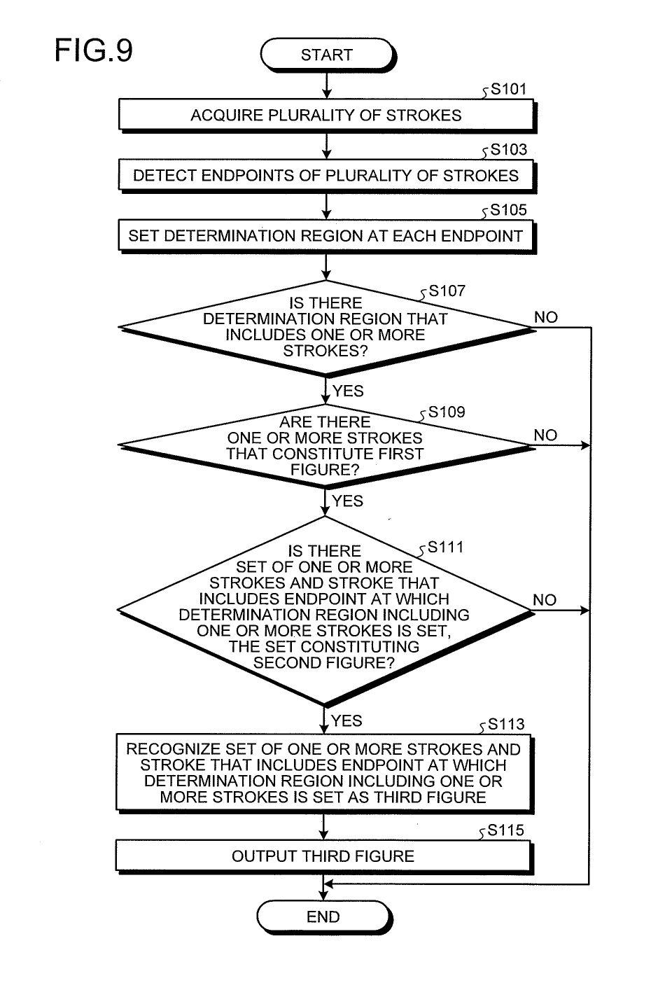

FIG. 9 is a flow chart illustrating an example of a procedure of recognition process performed by the recognition apparatus 10 according to the first embodiment.

First, the acquisition unit 13 acquires a plurality of strokes input from the input unit 11 (step S101).

Subsequently, the detector 15 detects endpoints of each of the plurality of strokes acquired by the acquisition unit 13 (step S103).

Subsequently, the setting unit 17 sets the determination region at each of the endpoints detected by the detector 15 (step S105).

Subsequently, the first determination unit 19 determines whether there is any determination region that includes one or more strokes (step S107). When there is no determination region that includes one or more strokes (No in step S107), the process ends.

On the other hand, when there is a determination region that includes one or more strokes (Yes in step S107), the second determination unit 23 determines whether there are one or more strokes that constitute the first figure (step S109). When there is no stroke that constitutes the first figure (No in step S109), the process ends.

On the other hand, when there are one or more strokes that constitute the first figure (Yes in step S109), the third determination unit 25 determines whether the stroke having the endpoint, at which the determination region including the one or more strokes is set, constitutes the second figure (step S111). When the stroke having the endpoint, at which the determination region including the one or more strokes is set, does not constitute the second figure (No in step S111), the process ends.

On the other hand, when the stroke having the endpoint, at which the determination region including the one or more strokes is set, constitutes the second figure (Yes in step S111), the recognizer 27 recognizes, as the third figure, the one or more strokes and the stroke having the endpoint at which the determination region including the one or more strokes is set (step S113).

Subsequently, the output unit 29 outputs the third figure recognized by the recognizer 27 (step S115).

As described above, according to the first embodiment, when a portion of the figure to be recognized can take various shapes, the figure to be recognized is recognized by separately determining a portion that can take a fixed shape like a symbol and determining a portion that can take various shapes. Thus, highly precise recognition can be achieved without causing increase in a storage area and increase in processing loads.

### Second Embodiment

In a second embodiment, an example will be explained of deciding a stroke having an endpoint, at which a determination region including one or more strokes is set, as a stroke to be determined whether to constitute a second figure. The following description focuses on a difference from the first embodiment, and a component having a function similar to a function of the first embodiment is provided with a name and symbol similar to a name and symbol of the first embodiment, and its description will be omitted.

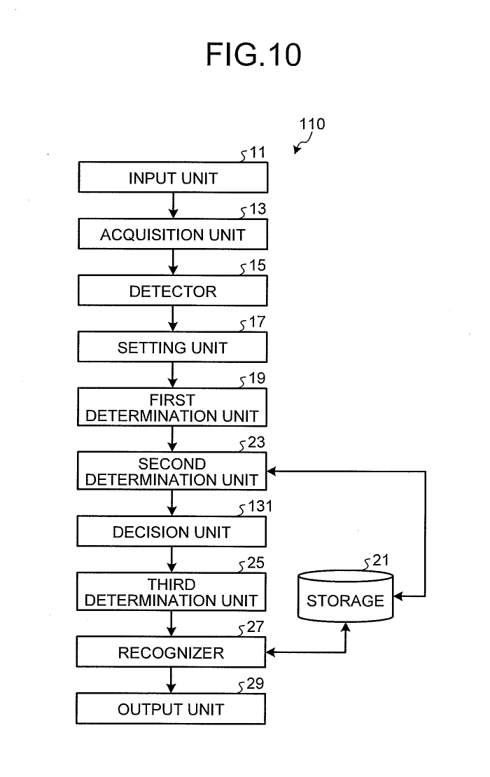

FIG. 10 is a configuration diagram illustrating an example of a recognition apparatus 110 according to the second embodiment. As illustrated in FIG. 10, the recognition apparatus 110 according to the second embodiment is different from the recognition apparatus according to the first embodiment in a decision unit 131.

When the second determination unit 23 determines that one or more strokes constitute a first figure, the decision unit 131 decides the stroke having the endpoint, at which the determination region including the one or more strokes is set, as the stroke to be determined whether to constitute the second figure.

Specifically, the decision unit 131 combines the stroke having the endpoint, at which the determination region including the one or more strokes is set, with a combinable stroke until combinable strokes do not exist to decide the combined stroke as the stroke to be determined. The combinable stroke is, for example, a stroke having an endpoint distance equal to or smaller than a fourth threshold, the endpoint distance being from the stroke having the endpoint at which the determination region including the one or more strokes is set.

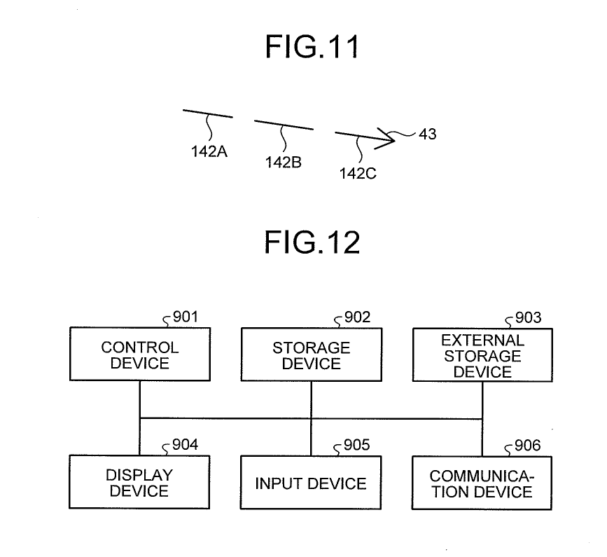

FIG. 11 is a diagram illustrating an example of a decision method of the stroke to be determined according to the second embodiment. In the example illustrated in FIG. 11, it is assumed that the stroke having the endpoint, at which the determination region including the one or more strokes is set, is a stroke 142C. In this case, the decision unit 131 checks the presence of the stroke having the endpoint distance from the stroke 142C, which is equal to or smaller than the fourth threshold and when there is no applicable stroke, the decision unit 131 decides the stroke 142C as the stroke to be determined. Here, a stroke 43 that includes one or more strokes is excluded from strokes to be combined. However, in the example illustrated in FIG. 11, since the endpoint distance between the stroke 142C and a stroke 142B is equal to or smaller than the fourth threshold, the decision unit 131 combines the stroke 142B with the stroke 142C.

In this case, the decision unit 131 checks the presence of a stroke having the endpoint distance from the stroke obtained by combining the stroke 142C and the stroke 142B, which is equal to or smaller than the fourth threshold. When there is no applicable stroke, the decision unit 131 decides the stroke obtained by combining the stroke 142C and the stroke 142B as the stroke to be determined. However, in the example illustrated in FIG. 11, since the endpoint distance between the stroke 142B and a stroke 142A is equal to or smaller than the fourth threshold, the decision unit 131 further combines the stroke 142A with the stroke obtained by combining the stroke 142C and the stroke 142B.

In this case, the decision unit 131 checks the presence of a stroke having the endpoint distance from the stroke obtained by combining the strokes 142A to 142C, which is equal to or smaller than the fourth threshold. When there is no applicable stroke, the decision unit 131 decides the stroke obtained by combining the strokes 142A to 142C as the stroke to be determined. In the example illustrated in FIG. 11, since there is no stroke having the endpoint distance from the stroke obtained by combining the strokes 142A to 142C, which is equal to or smaller than the fourth threshold, the decision unit 131 decides the stroke obtained by combining the strokes 142A to 142C as the stroke to be determined.

A third determination unit 25 determines whether the stroke to be determined decided by the decision unit 131 constitutes the second figure.

According to the second embodiment, even a dotted-line stroke corresponding to a shaft part of an arrow can be recognized.

### First Modification

In each of the above embodiments, when one or more strokes are included in the determination region, the second determination unit 23 may determine whether each combination of the one or more strokes constitutes the first figure. This configuration can also deal with a case where a stroke that serves as noise is included in the determination region in addition to the one or more strokes.

### Second Modification

In each of the above embodiments, when one or more strokes are included in the determination region, the second determination unit 23 may determine, for each divided region obtained by dividing the determination region, whether one or more strokes included in the divided region constitute the first figure. This configuration can also deal with a case where a stroke that serves as noise is included in the determination region in addition to the one or more strokes.

### Hardware Configuration

FIG. 12 is a diagram illustrating an example of a hardware configuration of the recognition apparatus according to each of the embodiments and each of the modifications. The recognition apparatus according to each of the embodiments and each of the modifications includes a control device 901, such as a CPU, a storage device 902, such as a ROM and a RAM, an external storage device 903, such as a HDD, a display device 904, such as a display, an input device 905, such as a touch panel, and a communication device 906, such as a communication interface. The recognition apparatus has a hardware configuration using a standard computer.

A program executed by the recognition apparatus according to each of the embodiments and each of the modifications is an installable file or an executable file. The program is stored in a computer-readable storage medium, such as a compact disk read only memory (CD-ROM), a compact disk recordable (CD-R), a memory card, a digital versatile disk (DVD), and a flexible disk (FD), and is provided.

The program executed by the recognition apparatus according to each of the embodiments and each of the modifications may also be configured to be stored in a computer connected to a network, such as the Internet, and to be provided by allowing download via the network. The program executed by the recognition apparatus according to each of the embodiments and each of the modifications may also be configured to be provided or distributed via the network, such as the Internet. The program executed by the recognition apparatus according to each of the embodiments and each of the modifications may also be configured to be incorporated in a device such as a ROM in advance and to be provided.

The program executed by the recognition apparatus according to each of the embodiments and each of the modifications has a modular configuration for implementing the above-described each unit in the computer. Actual hardware is configured to implement each unit in the computer by the CPU reading the program from the HDD into the RAM for execution.

The steps in the flow chart of each of the above embodiments may be performed by changing execution sequence, performing a plurality of steps concurrently, or performing the steps in a different sequence each time the steps are performed, as long as such an action does not contradict the step's property.

As described above, according to each of the embodiments and each of the modifications, even when a portion of the figure to be recognized can take various shapes, it is possible to perform highly precise recognition.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recognition apparatus comprising:
an acquisition unit to acquire a plurality of strokes;
a detector to detect endpoints of each of the plurality of strokes;
a setting unit to set a determination region for each of the endpoints;
a first determination unit to determine whether first one or more strokes are included in a first determination region;
a second determination unit to determine, when the first one or more strokes are included in the first determination region, whether the first one or more strokes constitute a first figure;
a third determination unit to determine, when the first one or more strokes constitute the first figure, whether second one or more strokes comprising the detected endpoints in the first determination region constitute a second figure;
a recognizer to recognize, when the second one or more strokes constitute the second figure, the first one or more strokes and the second one or more strokes as a third figure; and
an output unit to output the recognized the third figure.

2. The apparatus according to claim 1, wherein, based on a positional relationship between the first one or more strokes and the second one or more strokes, the third determination unit determines whether the second one or more strokes constitute the second figure.

3. The apparatus according to claim 1, further comprising a decision unit to decide, when the first one or more strokes constitute the first figure, the second one or more strokes comprising the detected endpoints in the first determination region whether to constitute the second figure, wherein
the third determination unit determines whether the second one or more strokes constitute the second figure.

4. The apparatus according to claim 3, wherein the decision unit decides existing other one or more strokes comprising detected endpoints in the first determination region combinable with the second one or more strokes to determine whether the combined strokes constitute a figure.

5. The apparatus according to claim 4, wherein the combinable strokes comprise endpoints, each of which has a distance from the endpoints of the second one or more strokes in the first determination region equal to or smaller than a threshold.

6. The apparatus according to claim 1, wherein, when the first one or more strokes are included in the first determination region, the second determination unit determines whether each combination of the first one or more strokes constitutes the first figure.

7. The apparatus according to claim 1, wherein, the second determination unit further configured to divide the first determination region into multiple divided regions, each of which comprises one or more strokes and determine whether the one or more strokes in each divided region constitute the first figure.

8. A recognition method comprising:
acquiring a plurality of strokes;
detecting endpoints of each of the plurality of strokes;
setting a determination region for each of the endpoints;
determining whether first one or more strokes are included in a first determination region;
further determining, when the first one or more strokes are included in the first determination region, whether the first one or more strokes constitute a first figure;
further determining, when the first one or more strokes constitute the first figure, whether second one or more strokes comprising the detected endpoints in the first determination region constitute a second figure;
recognizing, when the second one or more strokes constitute the second figure, the first one or more strokes and the second one or more strokes as a third figure; and
outputting the recognized third figure.

9. A non-transitory computer-readable medium comprising a program that causes a computer to perform:
acquiring a plurality of strokes;
detecting endpoints of each of the plurality of strokes;
setting a determination region for each of the endpoints;
determining whether first one or more strokes are included in a first determination region;
further determining, when the first one or more strokes are included in the first determination region, whether the first one or more strokes constitute a first figure;
further determining, when the first one or more strokes constitute the first figure, whether second one or more strokes comprising the detected endpoints in the first determination region constitute a second figure;
recognizing, when the second one or more strokes constitute the second figure, the first one or more strokes and the second one or more strokes as a third figure; and
outputting the recognized third figure.
